(19) United States
(12) Patent Application Publication
(10) Pub. No.: US 2025/0003554 A1
(43) Pub. Date: Jan. 2, 2025

(54) METHOD FOR DELIVERY OF LIQUID CRYOGEN

(71) Applicant: L'Air Liquide, Societe Anonyme pour l'Etude et l’Exploitation des Procedes Georges Claude, Paris (FR)

(72) Inventors: Joshua LIGHT, Houston, TX (US); Jerry HAYES, Houston, TX (US)

(73) Assignee: L'Air Liquide, Societe Anonyme pour l'Etude et l’Exploitation des Procedes Georges Claude, Paris (FR)

(21) Appl. No.: 18/214,860

(22) Filed: Jun. 27, 2023

(51) Int. Cl. F17C 5/02; F17C 13/04

(52) U.S. Cl. CPC F17C 5/02; F17C 13/04; F17C 2221/012; F17C 2223/0161; F17C 2225/0161; F17C 2227/043; F17C 2270/0168

(57) ABSTRACT

An improved delivery method is provided in which a user will equalize pressure in the stationary vessel and the transport by allowing gaseous cryogen from the stationary vessel to flow to the transport. Next the transport will pressure build to a pressure greater than the stationary vessel in order to make the delivery.

### FIELD OF THE INVENTION

The present invention relates an improved method for delivery of a liquid cryogen. In particular, it relates to systems for filling storage tanks with liquid cryogen from a delivery tank.

### BACKGROUND OF THE INVENTION

A cryogenic liquid is defined by Publication C-7 of the Compressed Gas Association Publication as a refrigerated liquid gas having a boiling point of −90° C. at 14.7 psia. As such, they are typically stored in insulated vessels at relatively low temperatures. While liquid cryogens are typically stored at super-atmospheric pressures, ordinarily their pressures are orders of magnitude lower than the pressure of the cryogen stored in gaseous form.

Typical cryogens used industrially include hydrogen, nitrogen, oxygen, argon, xenon, krypton, helium, and carbon dioxide. One technology for supplying liquid cryogens, such as liquid hydrogen (LH₂), is the pumping of the liquid cryogen to high pressures. For smaller, non-hydrogen energy end use applications, LH₂ pumps have typically been used to reach pressures up to 3,000 psig (206.8 bar). For the hydrogen energy market, higher pressures are typically encountered for various applications: medium-pressure applications and high-pressure applications. Medium-pressure applications, such as filling gaseous hydrogen distribution trailers, forklifts, or busses, require hydrogen at pressures of around 6,000 psig (413.7 bar). High-pressure applications, such as filling light duty or heavy duty vehicles, require hydrogen at pressure of around 12,000 psig (827.4 bar).

The storage and transportation of liquid hydrogen (LH2) are essential for many industries, including aerospace, energy, and transportation. Liquid hydrogen is a highly volatile and flammable material that requires specialized storage and handling systems to ensure safety and efficiency.

Traditionally, the transfer of LH₂ from a delivery tank to a storage tank involves a process known as pressure transfer. This method involves using a pump to pressurize the delivery tank and force the liquid hydrogen into the storage tank. However, this method has several limitations, including the risk of equipment failure, low transfer rates, and safety concerns. Additionally, given the extremely low operating temperatures, specialized pumps have to be constructed specifically for this cryogenic usage.

An alternative method for transferring LH₂ from a delivery tank to a storage tank is through the use of a gravity-fed system. This method involves transferring the LH₂ from the delivery tank to the storage tank by allowing it to flow under the force of gravity. However, this method is also associated with several challenges, including the need for specialized equipment and the potential for loss of LH₂ due to evaporation.

There is a need, therefore, for an improved system and method for filling liquid hydrogen into a storage tank from a delivery tank that is safe, efficient, and cost-effective

### SUMMARY OF THE INVENTION

The present invention is directed to an apparatus and process that satisfies at least one of these needs. In certain embodiments of the invention, no specialized pumping equipment is needed. Instead, the higher pressure of the stationary vessel is used to pressurize the delivery tank, such that the two pressures equalize. Following equalization in pressures, the pressure within the delivery tank is then increased, preferably due to heat leaks causing rising pressure, more preferably using a pressure building unit. Once the pressure has increased enough, flow is switched on and the liquid cryogen is delivered from the delivery tank to the stationary vessel.

In one embodiment, a method for delivering a liquid cryogen from a delivery tank to a stationary vessel is provided. In this embodiment, the method may include the steps of: positioning the delivery tank, wherein the delivery tank has an initial delivery pressure; providing the stationary vessel having an initial pressure; fluidly connecting the delivery tank with the stationary vessel using a combination of valves, a delivery hose, and stationary piping, wherein the combination of valves comprises a delivery valve and a gas valve, wherein the delivery hose connects the delivery valve to the stationary piping; allowing a pressure of the delivery tank and a pressure of the stationary vessel to equalize by allowing flow of gaseous cryogen from the stationary vessel to the delivery tank, said pressure being an equalization pressure; stopping flow of the gaseous cryogen into the delivery tank; building pressure within the delivery tank until pressure within the delivery tank reaches a minimum delivery pressure, wherein said minimum delivery pressure is higher than the equalization pressure; and transferring liquid cryogen from the delivery tank to the stationary vessel.

In optional embodiments of the method for delivering the liquid cryogen:
the liquid cryogen is liquid hydrogen;
the liquid cryogen is transferred to the stationary vessel from the delivery tank without the use of a pump;
the combination of valves further comprises a liquid valve;
the step of allowing the pressure of the delivery tank and the pressure of the stationary vessel to equalize comprises opening both the gas valve and the delivery valve such that gaseous cryogen from the stationary vessel flows from a top portion of the stationary vessel and down through the stationary piping, through the gaseous valve, into the delivery hose, and through the delivery valve before entering the delivery tank;
the step of building pressure is accomplished by closing the delivery valve and the gas valve and allowing heat leaks to build the pressure within the tank;
the step of allowing heat leaks to build further include allowing liquid hydrogen within a main body of the delivery tank to gravitationally flow through a piping system disposed at least partially below the main body of the delivery tank to increase heat leaks due to increased external surface area to volume of liquid hydrogen within the piping system as compared to the main body of the delivery tank;
a pressure building unit is in fluid communication with the delivery tank through at least one inlet conduit, an outlet conduit, and/or a gravity feed conduit; and/or
the step of transferring the liquid cryogen comprises opening the delivery valve and the gas valve, such that liquid cryogen flows from the delivery tank and through the delivery valve, into the delivery hose, through gas valve, up through the stationary piping, and into a top portion of the stationary vessel.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows a first step of an embodiment of the present invention.

FIG. 2 shows a second step of an embodiment of the present invention.

FIG. 3 shows a third step of an embodiment of the present invention.

FIG. 4 shows a fourth step of an embodiment of the present invention.

### DETAILED DESCRIPTION

While the invention may be described in connection with several embodiments, it will be understood that it is not intended to limit the invention to those embodiments. On the contrary, it is intended to cover all the alternatives, modifications and equivalence as may be included within the spirit and scope of the invention defined by the appended claims.

The full deployment of the advanced LH₂ delivery method will take a couple of years. In the meantime, the business would like to use principles of the advanced delivery method to improve the performance of our supply chain.

The most feasible method for improving the delivery with the existing equipment is termed the “improved delivery method”. With minor modifications, this delivery technique can take place with the existing vessels and trailers to yield some improvement to the LH₂ delivery efficiency. Using the improved delivery method, the driver will equalize pressure in the stationary vessel and the transport by allowing GH₂ from the stationary vessel to flow to the transport. Next the transport will pressure build to a pressure greater than the stationary vessel in order to make the delivery. The following steps will proceed as a normal delivery.

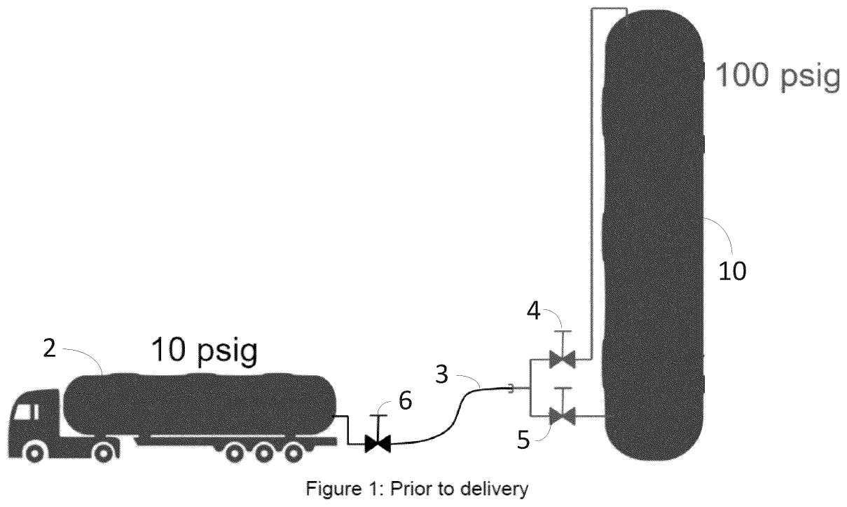

FIG. 1 provides a schematic representation of a first step of the improved delivery method in which the delivery tank 2 is put into position and hooked up to the delivery line 3. The delivery valve 6, gas valve 4, and liquid valve 5 are all in their closed position. In the example shown in the FIG. 1, the stationary vessel 10 has a pressure of about 100 psig and the delivery tank 2 2 is at 10 psig.

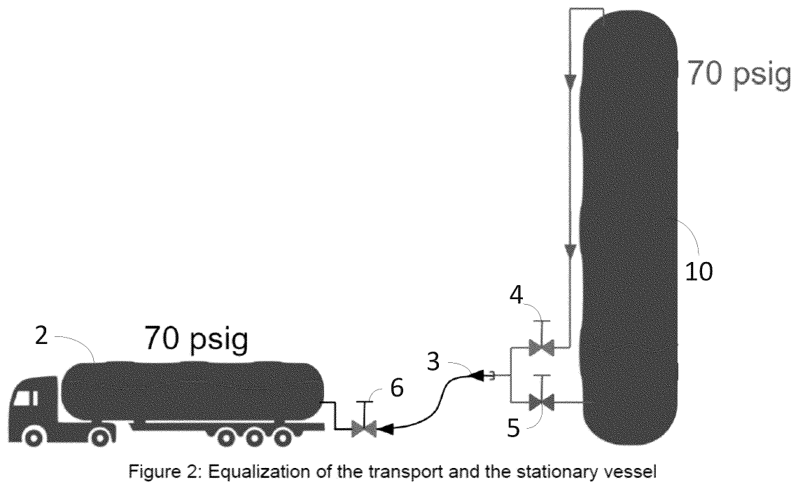

FIG. 2 provides a representation of an equalization step between the delivery tank 2 and the stationary vessel, in which the delivery valve 6 and the gas valve 4 are both opened, thereby allowing the pressure between the delivery tank 2 and the stationary vessel to equalize.

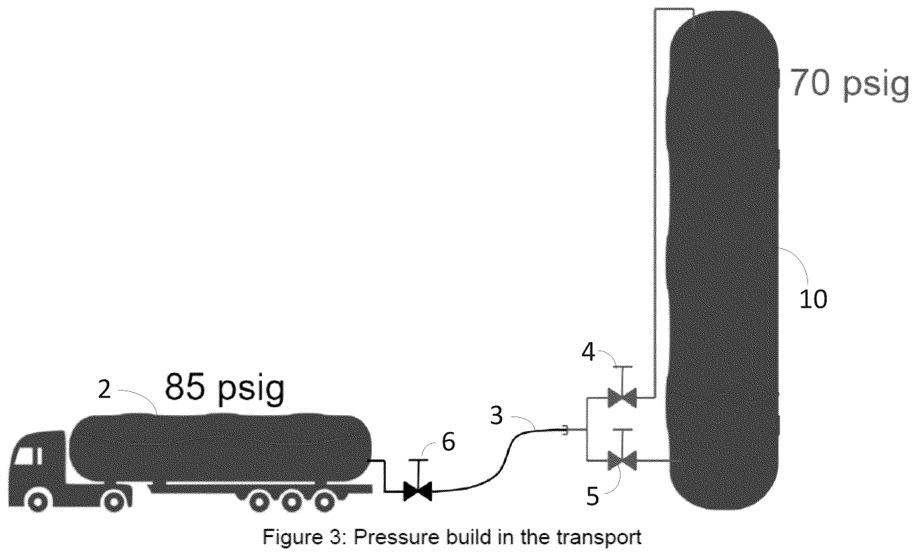

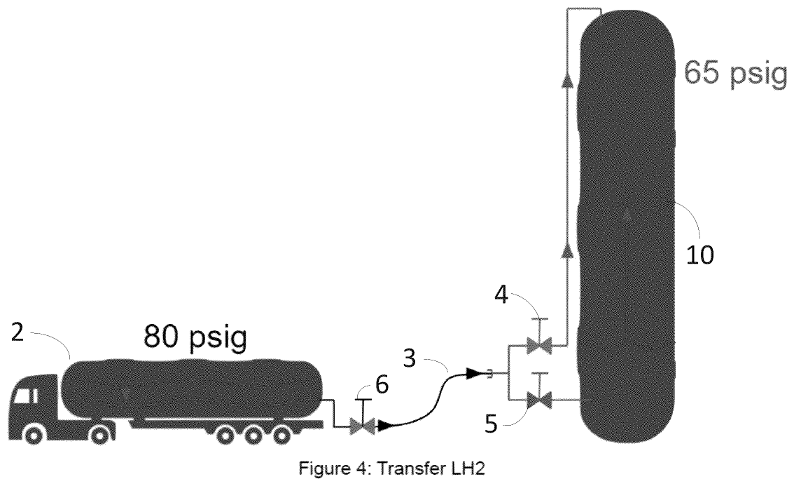

FIG. 3 provides a representation of a pressure build-up step. In this step, all valves are closed. Pressure will naturally build within the delivery tank 2 due to heat leaks (e.g., heat transfer from atmospheric to the delivery tank 2, or more preferably, using a pressure building unit (not shown), which comprises a plurality of tubes in fluid communication with the main body of the delivery tank 2). Once the delivery tank 2 has reached a minimum pressure transfer threshold, the user may proceed to the next step, which is illustrated in FIG. 4.

As shown in FIG. 4, delivery valve 6 and gas valve 4 are both opened, thereby allowing for flow from the delivery tank 2 into the stationary vessel 10 based on the overpressurization of the delivery tank 2.

Advantageously, this transfer can be accomplished without any specialized equipment or external pumps, thereby allowing for transport and delivery of liquid cryogens such as liquid hydrogen prior to specialized pumps being developed.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

I claim:

1. A method for delivering a liquid cryogen from a delivery tank to a stationary vessel, the method comprising the steps of:
positioning the delivery tank, wherein the delivery tank has an initial delivery pressure;
providing the stationary vessel having an initial pressure;
fluidly connecting the delivery tank with the stationary vessel using a combination of valves, a delivery hose, and stationary piping, wherein the combination of valves comprises a delivery valve and a gas valve, wherein the delivery hose connects the delivery valve to the stationary piping;
allowing a pressure of the delivery tank and a pressure of the stationary vessel to equalize by allowing flow of gaseous cryogen from the stationary vessel to the delivery tank, said pressure being an equalization pressure;
stopping flow of the gaseous cryogen into the delivery tank;
building pressure within the delivery tank until pressure within the delivery tank reaches a minimum delivery pressure, wherein said minimum delivery pressure is higher than the equalization pressure; and
transferring liquid cryogen from the delivery tank to the stationary vessel.

2. The method as claimed in claim 1, wherein the liquid cryogen is liquid hydrogen.

3. The method as claimed in claim 1, wherein the liquid cryogen is transferred to the stationary vessel from the delivery tank without the use of a pump.

4. The method as claimed in claim 1, wherein the combination of valves further comprises a liquid valve.

5. The method as claimed in claim 1, wherein the step of allowing the pressure of the delivery tank and the pressure of the stationary vessel to equalize comprises opening both the gas valve and the delivery valve such that gaseous cryogen from the stationary vessel flows from a top portion of the stationary vessel and down through the stationary piping, through the gaseous valve, into the delivery hose, and through the delivery valve before entering the delivery tank.

6. The method as claimed in claim 1, wherein the step of building pressure is accomplished by closing the delivery valve and the gas valve and allowing heat leaks to build the pressure within the tank.

7. The method as claimed in claim 6, wherein the step of allowing heat leaks to build further include allowing liquid hydrogen within a main body of the delivery tank to gravitationally flow through a piping system disposed at least partially below the main body of the delivery tank to increase heat leaks due to increased external surface area to volume of liquid hydrogen within the piping system as compared to the main body of the delivery tank.

8. The method as claimed in claim 1, wherein a pressure building unit is in fluid communication with the delivery tank through at least one inlet conduit, an outlet conduit, and/or a gravity feed conduit.

9. The method as claimed in claim 1, wherein the step of transferring the liquid cryogen comprises opening the delivery valve and the gas valve, such that liquid cryogen flows from the delivery tank and through the delivery valve, into the delivery hose, through gas valve, up through the stationary piping, and into a top portion of the stationary vessel.
